(19) United States
(12) Patent Application Publication
(10) Pub. No.: US 2015/0052305 A1
(43) Pub. Date: Feb. 19, 2015

(54) ARITHMETIC PROCESSING DEVICE, ARITHMETIC PROCESSING METHOD AND ARITHMETIC PROCESSING SYSTEM

(71) Applicant: FUJITSU LIMITED, Kawasaki-shi (JP)

(72) Inventor: Hiroaki KIMURA, Yokohama (JP)

(73) Assignee: FUJITSU LIMITED, Kawasaki-shi (JP)

(21) Appl. No.: 14/260,447

(22) Filed: Apr. 24, 2014

(30) Foreign Application Priority Data
Aug. 13, 2013 (JP) 2013-168216

(51) Int. Cl. G06F 12/08

(52) U.S. Cl. CPC G06F 12/0875
USPC 711/125

(57) ABSTRACT

An arithmetic processing device includes: a cache memory configured to store data; and a circuitry configured to: execute access instructions including a first access instruction and a second access instruction; and request, in a case where a first access to the cache memory based on the first access instruction has been completed and the first access instruction is a serializing instruction, a re-execution of the second access instruction subsequent to the serializing instruction when a second access to the cache memory based on the second instruction has been completed.

### CROSS-REFERENCE TO RELATED APPLICATION

This application is based upon and claims the benefit of priority of the prior Japanese Patent Application No. 2013-168216, filed on Aug. 13, 2013, the entire contents of which are incorporated herein by reference.

### FIELD

Embodiments discussed herein are related to an arithmetic processing device, an arithmetic processing method and an arithmetic processing system.

### BACKGROUND

An information processing device includes an instruction control unit that controls a thread serving as an execution unit for a sequence of instructions, and a cache control unit including a cache memory.

A technique of the related art is disclosed in International Publication Pamphlet No. WO 2008/155829.

### SUMMARY

According to one aspect of the embodiments, an arithmetic processing device includes: a cache memory configured to store data; and a circuitry configured to: execute access instructions including a first access instruction and a second access instruction; and request, in a case where a first access to the cache memory based on the first access instruction has been completed and the first access instruction is a serializing instruction, a re-execution of the second access instruction subsequent to the serializing instruction when a second access to the cache memory based on the second instruction has been completed.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of an arithmetic processing device;

FIG. 2 illustrates an example of a control method for an arithmetic processing device; and

FIG. 3 illustrates an example of a re-execution request determination circuit.

### DESCRIPTION OF EMBODIMENTS

For example, an information processing device simultaneously executes a plurality of threads, based on out-of-order where a store instruction and a load instruction each performing a memory access are executed regardless of an order described in a program, starting from an executable instruction. For example, using a thread, processing of a store instruction for a cache memory is executed. A determination circuit determines whether or not a subsequent load instruction for data at a target address of the store instruction has been executed before processing of a preceding load instruction, based on another thread including the preceding load instruction and the subsequent load instruction, and target data of the subsequent load instruction has been returned to an instruction control unit before processing of the store instruction. In a case where the determination circuit has determined that the target data has been returned to the instruction control unit before the processing of the store instruction, an instruction re-execution request circuit requests the instruction control unit to re-execute instructions from an instruction next to the preceding load instruction to the subsequent load instruction when the preceding load instruction is executed.

A mismatch based on the change of an execution order of the other instruction may be unresolved.

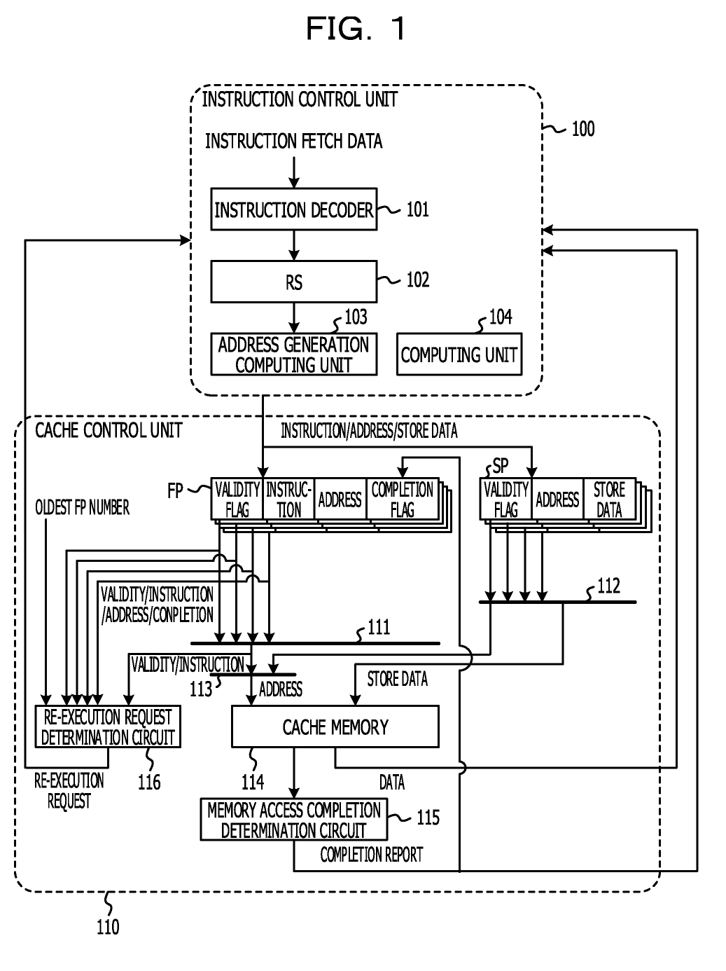

FIG. 1 illustrates an example of an arithmetic processing device. The arithmetic processing device includes an instruction control unit 100 and a cache control unit 110. The instruction control unit 100 and the cache control unit 110 may be included in a central processing unit (CPU). The instruction control unit 100 includes an instruction decoder 101, a reservation station (RS) 102, an address generation computing unit 103, and a computing unit 104. The cache control unit 110 includes a fetch port FP, a store port SP, selectors 111 to 113, a cache memory 114, a memory access completion determination circuit 115, and a re-execution request determination circuit 116. The cache memory 114 stores (holds) therein an instruction and data. The fetch port FP stores therein a validity flag, the type of instruction, an address, and a completion flag with respect to each fetch port number. The store port SP stores therein a validity flag, an address, and store data with respect to each store port number. For example, the fetch port FP has fetch port numbers of several to several tens of entries. The cache control unit 110 may hold the oldest fetch port number.

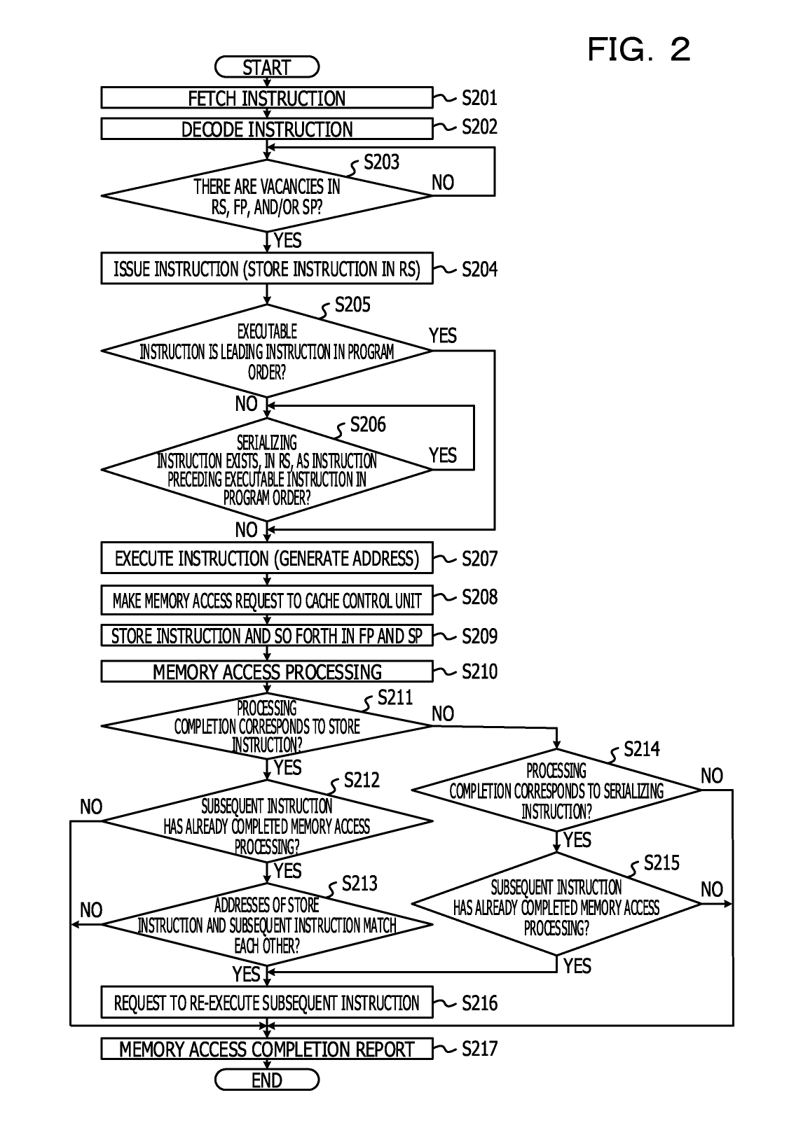

FIG. 2 illustrates an example of a control method for an arithmetic processing device. The arithmetic processing device illustrated in FIG. 1 may execute the control method illustrated in FIG. 2. In an operation S201, the instruction control unit 100 fetches an instruction within the cache memory 114, and inputs the fetched instruction to the instruction decoder 101. In an operation S202, the instruction control unit 100 decodes the input instruction using the instruction decoder 101. In an operation S203, the instruction control unit 100 checks whether or not there are vacancies in the reservation station 102, the fetch port FP, and/or the store port SP. The processing waits for the occurrence of a vacancy if there is no vacancy, and the processing proceeds to an operation S204 if there is a vacancy. In addition, the store port SP may be a port used only in a case where the decoded instruction is a store instruction.

In the operation S204, the instruction control unit 100 allocates the reservation station 102, the fetch port FP, and/or the store port SP, and issues an instruction. The instruction control unit 100 stores the instruction-issued instruction in the reservation station 102. In the reservation station 102, instructions used for accessing to the cache memory 114, for example, the load instruction, the store instruction, and so forth are stored. Other instructions are stored in another reservation station.

In an operation S205, the instruction control unit 100 checks whether or not an executable instruction out of the instructions stored in the reservation station 102 is a leading instruction in a program order. In a case where the executable instruction is not the leading instruction, the processing proceeds to an operation S206, and in a case where the executable instruction is the leading instruction, the processing proceeds to an operation S207.

In the operation S206, the instruction control unit 100 checks whether or not a serializing instruction exists as an instruction preceding the executable instruction in the program order, within the instructions stored in the reservation station 102. The serializing instruction is an instruction where it is difficult to change the order of an access to the cache memory 114, and may include a memory barrier instruction and an atomic instruction. The memory barrier instruction may be an instruction that executes a subsequent memory access instruction in the program order after completion of execution of all instructions preceding the memory barrier instruction (self-instruction) in a program. The atomic instruction may be an instruction where load of data, data change, and store are executed by one instruction, the data being stored in the cache memory 114, and it is difficult to access to states of executing the load, the data change, and the store within the atomic instruction.

In the operation S206, in a case where the serializing instruction exists, the instruction control unit 100 waits until the execution of the serializing instruction is completed. If the serializing instruction becomes non-existent as an instruction preceding the executable instruction in the program order, the processing proceeds to the operation S207.

In the operation S207, in order to access the cache memory 114 by executing the above-mentioned executable instruction, the instruction control unit 100 generates an address used for accessing the cache memory 114, using the address generation computing unit 103. The computing unit 104 performs computation by executing the executable instruction. By executing the executable instruction, the instruction control unit 100 performs out-of-order execution. Therefore, since the execution order of instructions may be different from the program order of instructions, a large increase in a processing speed may be obtained.

In an operation S208, the instruction control unit 100 outputs, to the cache control unit 110, a memory access request including the type of instruction, an address, and/or store data. For example, the store data may be only output in a case of the store instruction.

In an operation S209, the cache control unit 110 writes the type of instruction and the address into an allocated fetch port number of the fetch port FP, validates the validity flag, and puts the completion flag into being incomplete. In a case where the type of instruction is the store instruction, the cache control unit 110 further writes the address and the store data into the allocated store port number of the store port SP and validates the validity flag.

In an operation S210, the cache control unit 110 accesses the cache memory 114 in response to an instruction. For example, in a case where an instruction is the load instruction, the selector 111 selects and outputs the type of instruction and the address of the allocated fetch port number of the fetch port FP. The selector 113 selects and outputs the address output by the selector 111. The cache memory 114 loads data at the address output by the selector 113, and outputs the data at the address to the instruction control unit 100.

In a case where the instruction is the store instruction, the selector 112 selects and outputs the address and the store data of the allocated store port number of the store port SP. The selector 113 selects and outputs the address output by the selector 112. The cache memory 114 stores the store data output by the selector 112, at the address output by the selector 113.

In an operation S211, the re-execution request determination circuit 116 checks whether or not an instruction having completed access processing for the cache memory 114 is the store instruction. In a case of the store instruction, the processing proceeds to an operation S212, and in a case of not being the store instruction, the processing proceeds to an operation S214.

In the operation S212, the re-execution request determination circuit 116 checks whether or not access processing for the cache memory 114 based on an instruction subsequent to the store instruction has already been completed. The subsequent instruction may be every one of instructions located subsequent to the store instruction in the program order within the fetch port FP. In a case of having been completed, the processing proceeds to an operation S213, and in case of not having been completed, the processing proceeds to an operation S217.

In the operation S213, the re-execution request determination circuit 116 checks whether or not an access target address of the store instruction and an access target address of the subsequent instruction match each other. In a case where the addresses match each other, the processing proceeds to an operation S216 so as to modify an access order for the cache memory 114. For example, if the subsequent instruction accesses the same address before the execution of the store instruction is completed, a correct result is not obtained, and hence, a modification may be performed. In a case where the addresses do not match each other, the processing proceeds to the operation S217.

In the operation S214, the re-execution request determination circuit 116 checks whether or not an instruction having completed access processing for the cache memory 114 is the serializing instruction. In a case of the serializing instruction, the processing proceeds to an operation S215, and in a case of not being the serializing instruction, the processing proceeds to the operation S217. Control for the order of the serializing instruction is performed by the processing operation in the operation S206. Therefore, in the operation S214, it may not be determined that a completed instruction is the serializing instruction. In cases of a failure of the arithmetic processing device and so forth, in the operation S214 it may be determined that the completed instruction is the serializing instruction.

In the operation S215, the re-execution request determination circuit 116 checks whether or not access processing for the cache memory 114 based on an instruction subsequent to the serializing instruction has been completed. The subsequent instruction may be every one of instructions located subsequent to the serializing instruction in the program order, within the fetch port FP. In a case where the access processing has been completed, the processing proceeds to the operation S216 so as to modify the order of an access to the cache memory 114. For example, if the subsequent instruction accesses before the execution of the serializing instruction is completed, a correct result is not obtained, and hence, a modification may be performed. In a case where the access processing is not completed, the processing proceeds to the operation S217.

In the operation S216, the re-execution request determination circuit 116 outputs, to the instruction control unit 100, a re-execution request for a subsequent instruction. When having received the re-execution request, the instruction control unit 100 re-executes all subsequent instructions in the program order with respect to the store instruction or the serializing instruction after the completion of the store instruction or the above-mentioned serializing instruction. Therefore, the order of an access to the cache memory 114 may be modified to a correct order. The processing proceeds to the operation S217.

In the operation S217, the memory access completion determination circuit 115 outputs a memory access completion report to the instruction control unit 100, and puts, into being completed, a completion flag of the fetch port number of the fetch port FP corresponding to the memory access completion report.

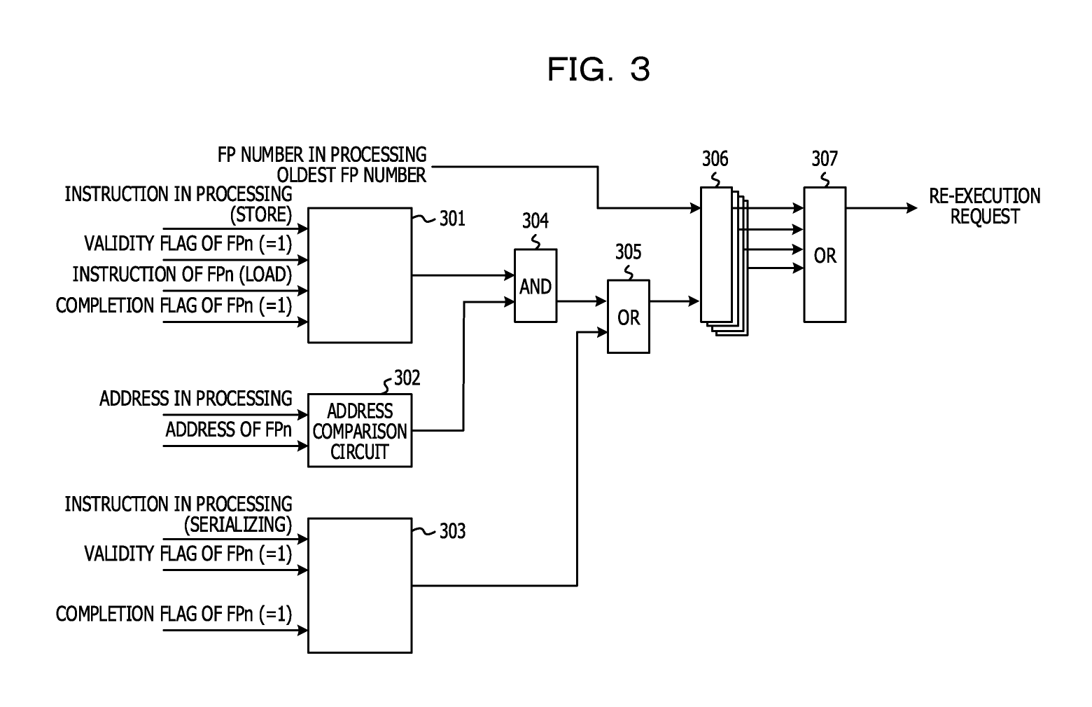

FIG. 3 illustrates an example of a re-execution request determination circuit. A re-execution request determination circuit 116 illustrated in FIG. 3 may be the re-execution request determination circuit 116 illustrated in FIG. 1. In a case where an instruction in processing is the store instruction (the operation S211), a validity flag of a fetch port number FPn is 1 (valid), an instruction of the fetch port number FPn is the load instruction, and a completion flag of the fetch port number FPn is 1 (completed) (S212), a determination circuit 301 may output “1”, and may output “0” in cases other than that.

An address comparison circuit 302 compares an address in processing with the address of the fetch port number FPn (the operation S213), and in a case where the two match each other, the address comparison circuit 302 may output “1”. In addition, in a case where the two do not match each other, the address comparison circuit 302 may output “0”.

An AND circuit 304 outputs a logical product of an output value of the determination circuit 301 and an output value of the address comparison circuit 302. In a case where the AND circuit 304 outputs “1”, the processing proceeds from the operation S213 to the operation S216 illustrated in FIG. 2.

In a case where an instruction in processing is the serializing instruction (the operation S214), the validity flag of the fetch port number FPn is 1 (valid), and the completion flag of the fetch port number FPn is 1 (completed) (the operation S215), the determination circuit 303 may output “1”, and may output “0” in cases other than that. In a case where the determination circuit 303 outputs “1”, the processing proceeds from the operation S215 to the operation S216 illustrated in FIG. 2.

An OR circuit 305 outputs a logical sum of an output value of the AND circuit 304 and an output value of the determination circuit 303. In a case where the output value of the OR circuit 305 is “1”, a selector 306 selects all fetch port numbers located subsequent to the store instruction or serializing instruction in processing in the program order, based on a fetch port number in processing and the oldest fetch port number, and outputs information of the selected fetch port numbers. The OR circuit 307 outputs re-execution requests for instructions of all the fetch port numbers output by the selector 306. For example, in a case where access (load) processing has been completed for any one of a plurality of instructions located subsequent to the store instruction or serializing instruction in processing in the program order, re-execution requests for all instructions located subsequent thereto are output.

The re-execution request determination circuit 116 receives (the type of) an instruction in processing and an address in processing, from the selector 111 in FIG. 1, and receives information of the fetch port number FPn from the fetch port FP in FIG. 1.

The instruction control unit 100 decodes an instruction, stores the decoded instruction in the reservation station 102, and executes the instruction stored in the reservation station 102 in an out-of-order manner. In the operation S214, the determination circuit 116 checks whether or not an instruction where access processing for the cache memory 114 has been completed by the instruction execution of the instruction control unit 100 is the serializing instruction. In a case of the serializing instruction, in the operation S215 the determination circuit 116 checks whether or not access processing for the cache memory 114 based on an instruction subsequent to the serializing instruction has been completed. In a case where the access processing has been completed, in the operation S216 the determination circuit 116 requests the instruction control unit 100 to re-execute the subsequent instruction. Therefore, also in a case where the serializing instruction is out-of-order executed, the order of an access to the cache memory 114 may be ensured.

In the operation S211, the determination circuit 116 checks whether or not an instruction where access processing for the cache memory 114 has been completed based on the instruction execution of the instruction control unit 100 is the store instruction. In a case of the store instruction, in the operation S212 the determination circuit 116 checks whether or not access processing for the cache memory 114 based on an instruction subsequent to the store instruction has been completed. In a case of having been completed, in the operation S213 the determination circuit 116 checks whether or not the addresses of accesses to the cache memory 114 of the store instruction and the subsequent instruction match each other. In a case of matching each other, in the operation S216 the determination circuit 116 requests the instruction control unit 100 to re-execute the subsequent instruction. Therefore, also in a case where the store instruction is out-of-order executed, the order of an access to the cache memory 114 may be ensured.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An arithmetic processing device comprising:
a cache memory configured to store data; and
a circuitry configured to:
execute access instructions including a first access instruction and a second access instruction; and
request, in a case where a first access to the cache memory based on the first access instruction has been completed and the first access instruction is a serializing instruction, a re-execution of the second access instruction subsequent to the serializing instruction when a second access to the cache memory based on the second instruction has been completed.

2. The arithmetic processing device according to claim 1, wherein
the circuitry executes the access instructions in an out-of-order manner.

3. The arithmetic processing device according to claim 1, wherein the circuitry requests, in a case where the first instruction is a store instruction, the re-execute of the second access instruction when an access address of the store instruction and an access address of the second access instruction match each other.

4. The arithmetic processing device according to claim 1, wherein the serializing instruction is a memory barrier instruction executing a subsequent access instruction in a program order after completion of execution of all instructions preceding the serializing instruction in a program.

5. The arithmetic processing device according to claim 1, wherein the serializing instruction is an atomic instruction executing load of data stored in the cache memory, data change and store by one instruction.

6. An arithmetic processing method, comprising:
completing a first access to a cache memory by a first execution of a first access instruction by a computer;
determining whether or not the first access instruction is a serializing instruction where an order of an access to the cache memory is not allowed to be changed;
completing a second access to the cache memory by a second execution of a second access instruction subsequent to the serializing instruction by the computer when the first access instruction is the serializing instruction; and
re-executing the second access instruction by the computer.

7. The arithmetic processing method according to claim 6, further comprising,
executing access instructions in an out-of-order manner.

8. The arithmetic processing method according to claim 6, further comprising,
requesting, in a case where the first instruction is a store instruction, the re-execute of the second access instruction when an access address of the store instruction and an access address of the second access instruction match each other.

9. The arithmetic processing method according to claim 6, wherein the serializing instruction is a memory barrier instruction executing a subsequent access instruction in a program order after completion of execution of all instructions preceding the serializing instruction in a program.

10. The arithmetic processing method according to claim 6, wherein the serializing instruction is an atomic instruction executing load of data stored in the cache memory, data change and store by one instruction.

11. An arithmetic processing system comprising:
a CPU; and
a cache memory configured to store data,
wherein the CPU requests, in a case where a first access to the cache memory based on a first access instruction has been completed and the first access instruction is a serializing instruction, a re-execution of a second access instruction subsequent to the serializing instruction when a second access to the cache memory based on the second instruction has been completed.

12. The arithmetic processing system according to claim 11, wherein the CPU executes the access instructions in an out-of-order manner.

13. The arithmetic processing system according to claim 11, wherein the CPU requests, in a case where the first instruction is a store instruction, the re-execute of the second access instruction when an access address of the store instruction and an access address of the second access instruction match each other.

14. The arithmetic processing system according to claim 11, wherein the serializing instruction is a memory barrier instruction executing a subsequent access instruction in a program order after completion of execution of all instructions preceding the serializing instruction in a program.

15. The arithmetic processing system according to claim 11, wherein the serializing instruction is an atomic instruction executing load of data stored in the cache memory, data change and store by one instruction.
